(19) United States
(12) Patent Application Publication
(10) Pub. No.: US 2008/0137786 A1
(43) Pub. Date: Jun. 12, 2008

(54) Adaptively modifying the even harmonic content of clock signals

(76) Inventor: Alan E. Waltho, San Jose, CA (US)

Correspondence Address: INTEL CORPORATION;c/o INTELLEVATE, LLC, P.O. BOX 52050, MINNEAPOLIS, MN, 55402, US

(21) Appl. No.: 11/636,313

(22) Filed: Dec. 8, 2006

(51) Int. Cl. H04B 1/10

(52) U.S. Cl. 375/346

(57) ABSTRACT

A wireless device that covers the wireless communication frequency bands incorporates a frequency domain monitor to adaptively modify the time domain waveform of a clock signal to suppress even order harmonics caused by asymmetry in the driver or load. Even order harmonics may be avoided where clock shifting is not possible and when combined with clock shifting the wireless device allows avoidance of both harmonics when two harmonics fall in-band of the receiver.

Technological developments permit digitization and compression of large amounts of voice, video, imaging, and data information. Evolving applications from these developments have greatly increased the need to transfer large amounts of data from one device to another or across a network to another system. To transfer data, mobile wireless devices incorporate Radio Frequency (RF) subsystems that operate over multiple frequency ranges. Computers have faster central processing units and substantially increased memory capabilities, which have increased the demand for devices that can more quickly store and transfer larger amounts of data. Operation of these facilities is synchronized by means of clock signals with very fast edges that cause harmonics that may extend into the Gigahertz range and cause interference to collocated wireless receivers operating in that frequency band. Thus, clock signal frequencies may be in a range where one or more harmonics fall in-band to any of the receivers. In some platforms, clock shifting may be used to avoid interference but improved methods for controlling interference from clock harmonics are needed in multi-radio subsystems.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a diagram that illustrates a wireless device that implements circuitry and algorithms in accordance with the present invention to suppress interference from even order clock signal harmonics that fall in-band to any of the radios;

FIG. 2 is a block diagram that illustrates one embodiment of the present invention for determining and minimizing harmonics generated by a clock source; and

FIG. 3 is a flow diagram that illustrates an algorithm to control harmonics detrimental to an RF platform.

It will be appreciated that for simplicity and clarity of illustration, elements illustrated in the figures have not necessarily been drawn to scale. For example, the dimensions of some of the elements may be exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

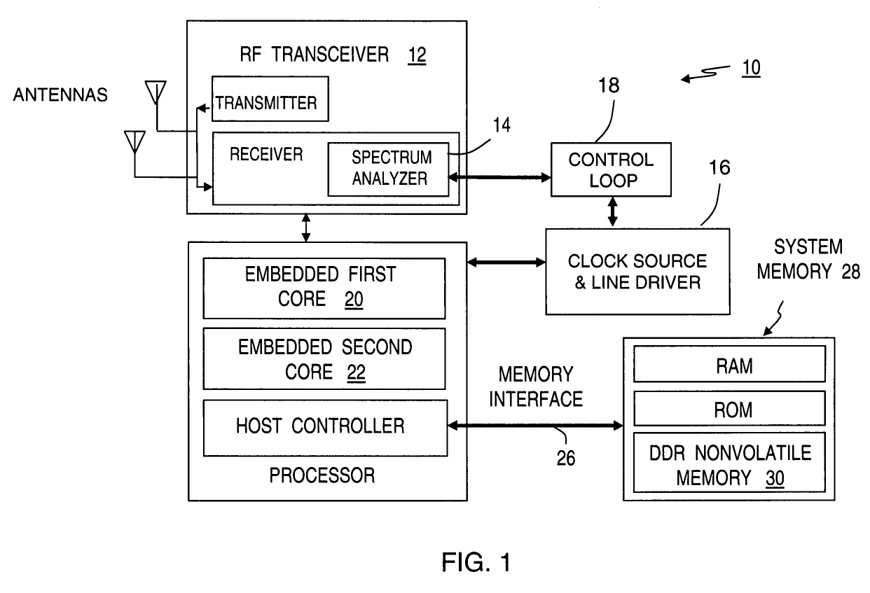

The embodiment illustrated in FIG. 1 shows a platform 10 that includes one or more radios to allow communication with other over-the-air communication devices. Platform 10 may operate in wireless networks such as, for example, Wireless Fidelity (Wi-Fi) that provides the underlying technology of Wireless Local Area Network (WLAN) based on the IEEE 802.11 specifications, WiMax and Mobile WiMax based on IEEE 802.16-2005, Wideband Code Division Multiple Access (WCDMA), and Global System for Mobile Communications (GSM) networks, although the present invention is not limited to operate in only these networks. The radio subsystems collocated in platform 10 provide the capability of communicating in an RF/location space with the other devices in the network.

Whereas prior art radios may suffer from interference caused by harmonics from clock signals in the frequency band where the wireless receivers are operating, the features of platform 10 includes circuitry and an algorithm for adaptively modifying the even harmonic content of the clock signals. By dynamically monitoring the harmonic radiation, the interference caused by the even harmonics of the clock signals may be adaptively suppressed to reduce or eliminate interference to the radio receivers. Accordingly, platform 10 includes a closed loop system that in one embodiment of the transceiver dynamically adjusts the bias of a driver circuit to compensate for temperature and load variations in accordance with the present invention. In another embodiment, parameters other than a bias may be dynamically adjusted to mitigate interference.

It should be noted that platform 10 may have applications in a variety of products. For instance, the claimed subject matter may be incorporated into desktop computers, laptops, smart phones, MP3 players, cameras, communicators and Personal Digital Assistants (PDAs), medical or biotech equipment, automotive safety and protective equipment, automotive infotainment products, etc. However, it should be understood that the scope of the present invention is not limited to these examples.

FIG. 1 illustrates the mobile platform 10 with a transceiver 12 and antenna to receive and transmit a modulated signal. The figure shows a simplistic embodiment to illustrate the coupling of antenna(s) to the transceiver to accommodate modulation/demodulation. In general, analog front end transceiver 12 may be a stand-alone Radio Frequency (RF) discrete or integrated analog circuit, or transceiver 12 may be embedded with a processor as a mixed-mode integrated circuit where the processor processes functions that fetch instructions, generate decodes, find operands, and perform appropriate actions, then stores results. A narrow band spectrum analyzer function 14 may be embedded into the receiver and used to monitor the interference signal falling in-band on the receiver channel. The clock source and line driver 16 provides the clocking for the processor and other functions on platform 10. A control loop 18 may be used to modify the bias or other conditions of the line driver 16 that is used to suppress interference from the clock harmonics falling in-band on the radio receiver channels as monitored by the spectrum analyzer function. The processor may include baseband and applications processing functions and utilize one or more processor cores 20 and 22 to handle application functions and allow processing workloads to be shared across the cores. The processor may transfer data through an interface 26 to memory storage in a system memory 28.

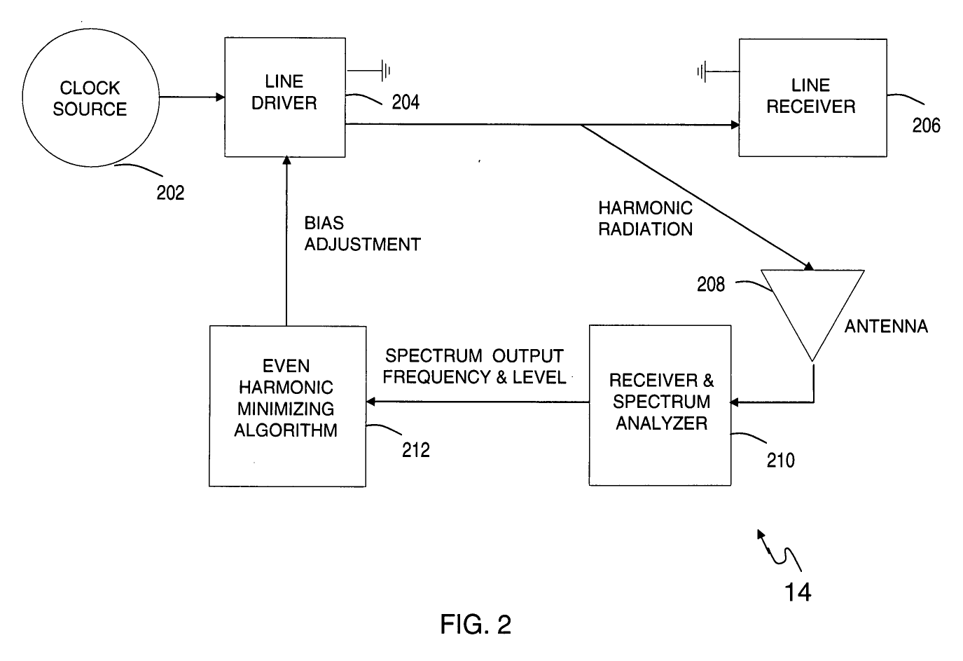

FIG. 2 is a block diagram that illustrates one embodiment of the present invention for spectrum analyzer 14, clock source and line driver 16, and control loop 18. As shown in the figure, transceiver 12 includes the receiver and spectrum analyzer block 210, a clock source 202 that generates a clock signal and a line driver 204 to provide buffering, selected shaping and proper drive capabilities for distribution of the clock signals to other functions via a transmission line. A line receiver 206 is coupled to receive signals from the line driver 204. An antenna 208 receives harmonic radiations as emitted by the line driver 204. Antenna 208 is coupled to the receiver and spectrum analyzer 210 to analyze the over the air received signals. The receiver and spectrum analyzer 210 provides a spectrum output of the frequency and the level of the received signals. A closed loop control in the form of an even order harmonic minimizing algorithm 212 is coupled to the receiver and spectrum analyzer 210 to generate a bias adjustment to the line driver 204.

The figure shows a simplistic embodiment that illustrates a closed loop system that enables an adjustment to the bias supplied to line driver 204. The bias applied to line driver 204 is used to compensate for temperature changes and impedance load variations that would alter the shape of the pulses generated by line driver 204 such as, for example, the rise and fall times of those pulses. In the time domain it would be difficult to detect any asymmetry in the pulse shape of the signal generated by the line driver 204, and therefore, the closed loop system includes a spectrum analyzer to provide the high sensitivity needed at the specific high order harmonic frequencies. The spectrum analyzer function uses a Fast Fourier Transform (FFT) processor that is typically part of the receiver, but used by the receiver and spectrum analyzer 210 to periodically monitor the level of the even harmonic generated in the signal that is the output of line driver 204.

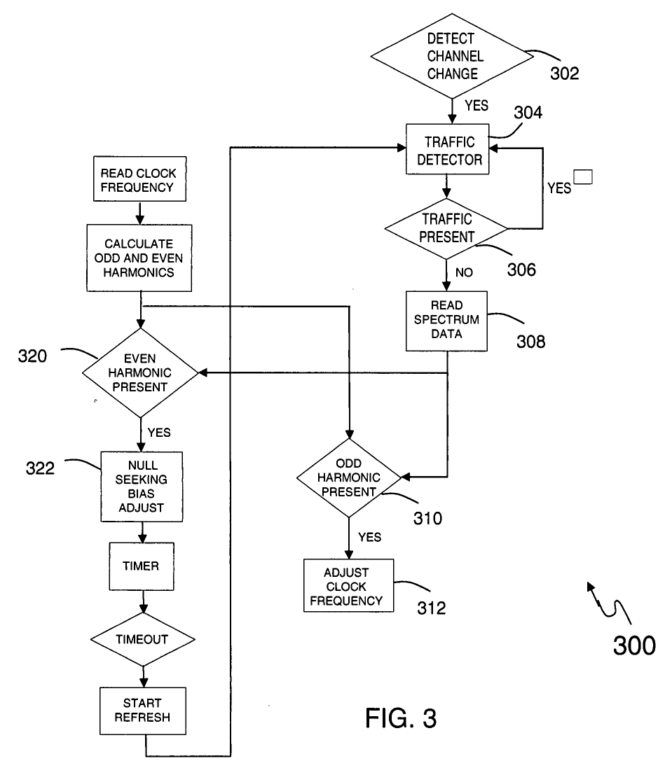

Operation of the clock generator and spectrum analyzer 14 may be described with reference to the flow diagram illustrated in FIG. 3. Method 300 or portions thereof are performed by the processor, the clock generator and spectrum analyzer 14 combination of an electronic system. Method 300 is not limited by the particular type of apparatus, software element, or system performing the method. Also, the various actions in method 300 may be performed in the order presented, or may be performed in a different order.

Method 300 is shown beginning at process step 302 that detects receiver communication channel changes. Process step 304 is a traffic detector and process step 306 detects whether traffic is present. Following the switching on or the change of channels in the receiver, and in the absence of any received traffic, the output of the spectrum analyzer is monitored to detect any clock harmonics that may be present (see process step 308). Spectrum analyzer 210 (see FIG. 2) is capable of performing frequency response measurements and measuring the magnitude and phase response of amplifiers and components in the system. The detected frequencies from any of the receiver components may be compared with predicted harmonic frequencies of the active clocks to determine the clock sources and the order of the harmonics.

In process step 310 the closed loop system determines whether odd harmonics are present. For odd order harmonics the clock frequencies may be adjusted to shift the odd order harmonic frequencies out of the receive channel frequency band (see process step 312). In process step 320 the closed loop system determines whether even harmonics are present, and if so, the remaining even order harmonics may then be suppressed to a minimum value (see process step 322) by adjusting the clock transmitter bias in accordance with the present invention. For balanced transmission, adjusting one side of the balanced loads may be possible.

By now it should be apparent that a multi-band frequency system that covers the wireless communication frequency bands has been shown to avoid even order harmonics where clock shifting is not possible and when combined with clock shifting allows avoidance of both harmonics when two harmonics fall in-band of the receiver. Thus, by implementing the inventive embodiments a frequency domain monitor may be incorporated to adaptively modify the time domain waveform of a clock signal to suppress even order harmonics caused by asymmetry in the driver or load.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A method of minimizing interference in radios as generated by even order harmonics of a clock, comprising:
using a frequency domain monitor to adaptively modify a time domain waveform of a clock signal to suppress even order harmonics caused by asymmetry in a line driver.

2. The method of claim 1 further including detecting receiver communication channel changes in the radios.

3. The method of claim 2 further including using a traffic detector to detect communication channel traffic.

4. The method of claim 3 wherein following a switching on or a change of channels in the radio, and in an absence of any traffic in a receive channel frequency band, the method further includes monitoring an output of the frequency domain monitor to detect any clock harmonics that may be present.

5. The method of claim 4 further including comparing the detected clock harmonics from receiver components with predicted harmonic frequencies of active clocks.

6. The method of claim 4 further including determining whether even harmonics are present, and if so, suppressing the remaining even order harmonics by adjusting a clock line driver bias.

7. A multi-band radio comprising:
a frequency domain monitor to adaptively modify a time domain waveform of a clock signal to suppress even order harmonics caused by asymmetry in a driver.

8. The multi-band radio of claim 7 wherein the frequency domain monitor looks at an output of the frequency domain monitor to detect any clock harmonics that may be present.

9. The multi-band radio of claim 7 wherein the frequency domain monitor determines whether even harmonics are present, and if so, suppresses remaining even order harmonics by adjusting a bias in the driver.

10. A single-band radio comprising:
a frequency domain monitor to adaptively modify a time domain waveform of a clock signal to suppress even order harmonics caused by asymmetry in a driver.

11. The single-band radio of claim 10 wherein the frequency domain monitor looks at an output of the frequency domain monitor to detect any clock harmonics that may be present.

12. The single-band radio of claim 10 wherein the frequency domain monitor determines whether even harmonics are present, and if so, suppresses remaining even order harmonics by adjusting a bias in the driver.

13. A radio comprising:
a line driver to receive a bias to alter a shape of pulses generated for the multi-band radio; and
a closed loop system to monitor harmonic radiation by the line driver and enable an adjustment to the bias supplied to the line driver.

14. The radio of claim 13 wherein the bias applied to the line driver is used to compensate for temperature changes and impedance load variations that alter the shape of the pulses generated by the line driver.

15. The radio of claim 13 wherein the closed loop system includes a spectrum analyzer with a Fast Fourier Transform (FFT) processor to periodically monitor a level of even harmonics generated by the line driver.

16. The radio of claim 13 wherein the closed loop system processes an output of the spectrum analyzer and uses an even harmonic minimizing algorithm to generate the bias supplied to the line driver.
